(19) United States
(12) Patent Application Publication
(10) Pub. No.: US 2024/0417597 A1
(43) Pub. Date: Dec. 19, 2024

(54) SILVER - CARBON ADHESIVE FOR X-RAY WINDOW

(71) Applicant: Moxtek, Inc., Orem, UT (US)

(72) Inventor: Ghazaleh ALLAEDINI, Orem, UT (US)

(21) Appl. No.: 18/665,774

(22) Filed: May 16, 2024

Related U.S. Application Data
(60) Provisional application No. 63/521,658, filed on Jun. 17, 2023.

(51) Int. Cl. C09J 1/00; C09J 5/06; C09J 9/02; C09J 11/06; H01J 35/18

(52) U.S. Cl. CPC C09J 1/00; C09J 5/06; C09J 9/02; C09J 11/06; H01J 35/18

(57) ABSTRACT

An x-ray window comprises a housing with a flange encircling an aperture. A thin film is located on the flange and spans the aperture. An adhesive is between an outer ring of the thin film and the flange. The adhesive mounts the thin film to the housing. The adhesive comprises silver and carbon.

### PRIORITY CLAIM

Priority is claimed to U.S. Patent Application No. 63/521,658, filed Jun. 17, 2023, which is hereby incorporated herein by reference.

### FIELD OF THE INVENTION

The present application is related to x-ray windows.

### BACKGROUND

X-ray windows are designed to transmit a high percent of x-rays, even low energy x-rays. X-ray windows are used in expensive systems requiring high reliability. High system requirements result in demanding characteristics of the x-ray window.

### BRIEF DESCRIPTION OF THE DRAWINGS (DRAWINGS MIGHT NOT BE DRAWN TO SCALE)

FIG. 1 is a cross-sectional side-view of an x-ray window 10 with an adhesive 13 sealing a thin film 12 to a housing 11.

FIG. 2 is a cross-sectional side-view illustrating a first step in a method of making an x-ray window, including placing an adhesive 13 on a flange 11f of a housing 11, on an outer ring 12o of a thin film 12, or on both.

### REFERENCE NUMBERS IN THE DRAWINGS

x-ray window 10
housing 11
aperture 11a
flange 11f
thin film 12
outer ring 12o
adhesive 13

Definitions. The following definitions, including plurals of the same, apply throughout this patent application.

As used herein, the term “encircling” and “encircled by” mean surrounding or forming a loop around, but these terms are not limited to a circular shape.

As used herein, the term “MPa” means megapascals (106 pascals).

As used herein, the term “ring” refers to a shape that encircles or forms a loop around, but this term is not limited to a circular shape.

As used herein, the terms “on”, “located on”, “located at”, and “located over” mean located directly on or located over with some other solid material between. The terms “located directly on”, “adjoin”, “adjoins”, and “adjoining” mean direct and immediate contact.

Unless explicitly noted otherwise herein, all temperature-dependent values are such values at 25° C.

### DETAILED DESCRIPTION

An x-ray window can include a thin film mounted by an adhesive to a housing. Useful characteristics of x-ray windows include (1) low gas permeability, (2) low outgassing, (3) high strength, (4) low visible and infrared light transmission, (5) high x-ray flux, (6) low atomic number materials, (7) corrosion resistance, (8) high reliability, (9) low-cost, (10) high temperature durability, (11) coefficient of thermal expansion compatibility, (12) a leak-proof, reliable bond between the thin film, the adhesive, and the housing, and (13) high electrical conductivity. Each x-ray window design is a balance between these characteristics.

A device that uses an x-ray window can have an internal vacuum. The internal vacuum can aid device performance. For example, an internal vacuum for an x-ray detector can minimize gas attenuation of incoming x-rays and allow easier cooling of the x-ray detector. Permeation of gas through the x-ray window can degrade the internal vacuum. Thus, low gas permeability is a desirable x-ray window characteristic.

Outgassing from x-ray window materials can degrade the internal vacuum of the device. Thus, selection of materials with low outgassing is useful.

The x-ray window can face vacuum on one side and atmospheric pressure on an opposite side. Therefore, the x-ray window thin film may need strength to withstand this differential pressure.

Visible and infrared light can cause undesirable noise in the x-ray detector. The ability to block transmission of visible and infrared light is another useful characteristic of x-ray windows.

A high x-ray flux through the x-ray window thin film allows rapid functioning of the x-ray detector. Therefore, high x-ray transmissivity through the x-ray window thin film is useful.

Detection and analysis of low-energy x-rays is needed in some applications. High transmission of low-energy x-rays is thus another useful characteristic of x-ray window thin film.

X-rays can be used to analyze a sample. X-ray noise from surrounding devices, including from the x-ray window, can interfere with a signal from the sample. X-ray noise from high atomic number materials are more problematic. It is helpful, therefore, for the x-ray window to be made of low atomic number materials.

X-ray windows are used in corrosive environments, and may be exposed to corrosive chemicals during manufacturing. Thus, corrosion resistance is another useful characteristic of an x-ray window.

X-ray window failure is intolerable in many applications. For example, x-ray windows are used in analysis equipment on Mars. High reliability is a useful x-ray window characteristic.

X-ray window customers demand low-cost x-ray windows with the above characteristics. Reducing x-ray window cost is another consideration.

The ability to withstand high temperatures is a useful characteristic of the x-ray window. The x-ray device may need to withstand high temperatures during manufacturing, such as during brazing.

Compatibility between the housing, the thin film, and the adhesive is useful. A low difference in coefficient of thermal expansion between these materials can result in a more robust hermetic seal. This is particularly important if the x-ray window will be subjected to large temperature fluctuations.

A tight bond, to the housing and to the x-ray window, is another useful characteristic of the adhesive. The housing and the x-ray window are typically made of different materials, and the adhesive should bond well to both materials.

In a transmission-target x-ray tube, electrons hit a target material on the x-ray window. These electrons can then flow to ground or to a positive voltage. The resulting electrical current can flow from the thin film to and through the adhesive then to and through the housing. Therefore, high electrical conductivity of the thin film, the adhesive, and the housing is useful.

The x-ray windows described herein, and x-ray windows manufactured by the methods described herein, can have these useful characteristics. Each example may satisfy one, some, or all of these useful characteristics.

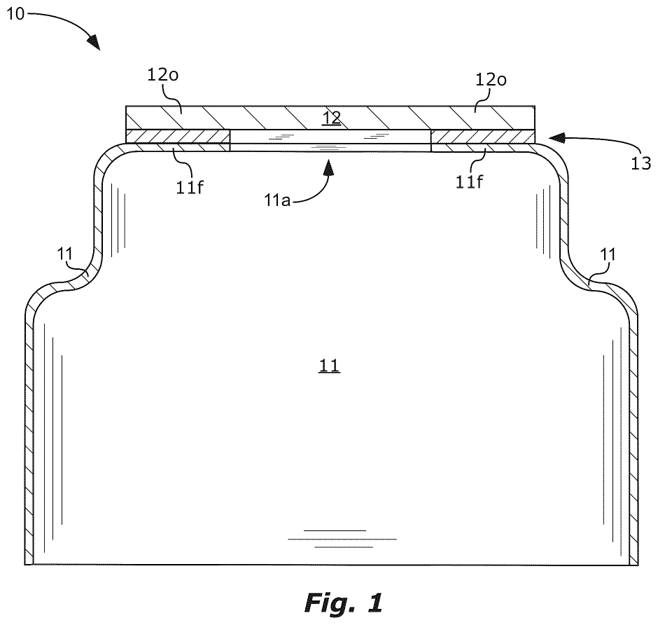

As illustrated in FIG. 1, the x-ray window 10 can comprise a housing 11 with a flange 11f encircling an aperture 11a. The housing 11 can be metallic. Example materials for the housing 11 include iron, nickel, or both.

A thin film 12 can be located on the flange 11f and can span the aperture 11a. Example materials for the thin film 12 include beryllium, amorphous carbon, boron, silicon nitride, aluminum, or combinations thereof. The thin film 12 can include multiple layers, with each layer made of one or more of the aforementioned materials.

An adhesive 13 can be located between an outer ring 12o of the thin film 12 and the flange 11f. The adhesive 13 can be an epoxy. The adhesive 13 can mount the thin film 12 to the housing 11. The adhesive 13 can adjoin the flange 11f. The adhesive 13 can adjoin the thin film 12. The adhesive 13 can form a hermetic seal between the flange 11f and the thin film 12.

The adhesive 13 can be made of materials to achieve the x-ray window 10 characteristics listed above. For example, the adhesive 13 can include silver and carbon. The adhesive 13 can include silver, carbon, graphene, epoxy resin, methyl-5-norbornene-2,3-dicarboxylic anhydride, glycerol, imidazole, trimellitic anhydride, or any combination of these chemicals.

The adhesive can include silver. Silver provides electrical conductivity, making it suitable for applications requiring electrical connections or grounding. Silver has high thermal conductivity for heat dissipation. Carbon is a gas and moisture barrier, enhances mechanical properties, and adds antistatic properties due to its lightweight nature.

The adhesive 13 can include ≥30 weight percent or ≥50 weight percent silver. The adhesive 13 can include ≤60 weight percent silver or ≤70 weight percent silver. Within ≥30 weight percent and ≤70 weight percent, silver provides a balance of electrical conductivity, thermal conductivity, adhesion strength, corrosion resistance, formulation flexibility, and cost-effectiveness for various industrial, electronic, medical, and even antimicrobial applications.

The adhesive 13 can include graphene. Graphene improves tensile strength, toughness, and flexibility. Graphene is a gas and moisture barrier. Graphene has thermal conductivity for heat dissipation. Graphene is lightweight. One example adhesive 13 is G6E-HTNS sold by Graphene Laboratories, Inc.

The adhesive 13 can include ≥0.01 weight percent and ≤1 weight percent graphene. This graphene weight percent range offers a combination of improved mechanical and electrical properties, thermal conductivity, lightweight, and barrier properties, compatible with a wide range of adhesive systems.

The adhesive 13 can include epoxy resin. Epoxy resin is chemically resistant to corrosion, has low shrinkage, maintains dimensional stability, and is adaptable to various applications. The adhesive 13 can include ≥10 weight percent and ≤30 weight percent epoxy resin. Within this range, the epoxy resin can optimize curing kinetics for proper working time, curing, and sufficient bond strength development without excessive shrinkage or brittleness.

The adhesive 13 can include methyl-5-norbornene-2,3-dicarboxylic anhydride (CAS 25134-21-8). Methyl-5-norbornene-2,3-dicarboxylic anhydride forms crosslinks within the adhesive matrix, enhancing overall strength, toughness, and durability, with low volatility to minimize shrinkage during curing. The adhesive 13 can include ≥10 weight percent and ≤30 weight percent methyl-5-norbornene-2,3-dicarboxylic anhydride. This range balances toughness, chemical resistance, curing control, compatibility, and cost-effectiveness for various industrial applications. Within this range formulators can achieve the desired performance while minimizing material costs.

The adhesive 13 can include glycerol (CAS 56-81-5). Glycerol is hygroscopic, and thus attracts and retains moisture to prevent drying out or brittleness. Glycerol is also a plasticizer, enhancing the adhesive's ability to accommodate movement without losing adhesion or cohesion. The adhesive 13 can include ≥1 weight percent and ≤5 weight percent glycerol. This range facilitates strong bond formation during curing, ensuring proper curing and adequate bond strength development.

The adhesive 13 can include trimellitic anhydride (CAS 552-30-7). Trimellitic anhydride is a crosslinking agent, and provides high mechanical strength and chemical resistance. The adhesive 13 can include ≥1 weight percent and ≤5 weight percent trimellitic anhydride. This range influences the rate of cure, allowing adequate working time and curing flexibility, resulting in optimal bond formation and rate of reaction.

The adhesive 13 can include imidazole (CAS 228-32-4). Imidazole is a pH buffer. Imidazole maintains stability during storage and processing. Imidazole facilitates chemical reactions between adhesive components. Imidazole promotes polymerization of resin systems. The adhesive 13 can include ≤0.1 weight percent imidazole. This range is best for imidazole to act as a catalyst and to control curing kinetics, ensuring precise working time and curing speed for consistent adhesive performance over time.

The adhesive 13 can have a hardness to provide a durable hermetic seal between the flange 11f and the thin film 12. For example, the adhesive 13 can have a Shore Hardness that is at least 50 D, at least 60 D, at least 70 D, or at least 80 D. Shore Hardness that is at least 70 D provides improved wear resistance, higher load-bearing capacity, and reduced vulnerability to surface damage.

The adhesive 13 can have a flexural modulus that can help reduce thin film strain during temperature fluctuation. For example, the adhesive 13 can have a flexural modulus that is ≥50 MPa, ≥100 MPa, or ≥130 MPa. The adhesive 13 can have a flexural modulus that is ≤ 200 Mpa, ≤350 Mpa, or ≤600 MPa. Within these ranges, the adhesive effectively distributes mechanical loads and stresses across bonded joints, enhancing overall strength and stability.

The adhesive 13 can have a volume resistivity to allow for electrical current flow from the thin film 12 to the flange 11f. For example, the adhesive 13 can have a volume resistivity that is ≤0.005 Ω-cm, ≤0.01 Ω-cm, or ≤0.1 Ω-cm. With volume resistivity ≤0.01 Ω-cm, the adhesive establishes effective electrical grounding connections, provides EMI shielding, and facilitates static dissipation to prevent damage to sensitive components.

The x-ray window, constructed of materials as described herein, can withstand high temperatures. For example, x-ray window can be capable of withstanding ≥250° C. or ≥300° C. without degradation.

### Method

A method of making an x-ray window can include some or all of the following steps:

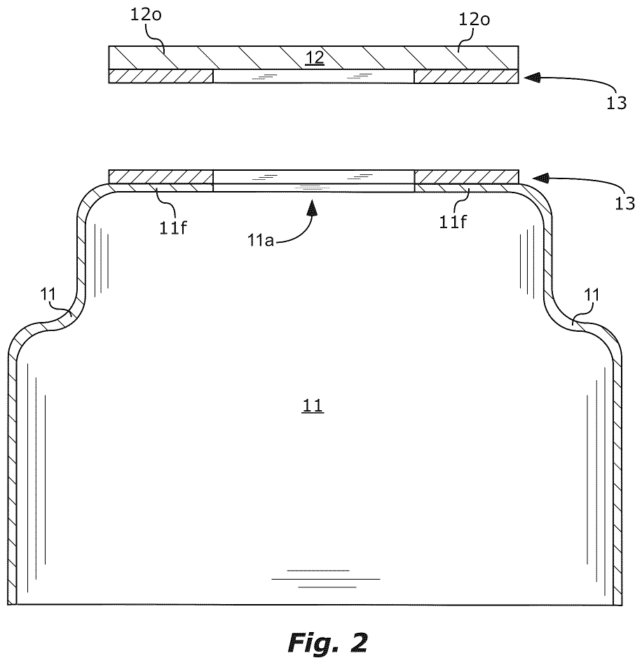

A first step (FIG. 2) can include placing an adhesive 13 on a flange 11f of a housing 11, on an outer ring 12o of a thin film 12, or on both.

A second step (FIG. 1) can include placing the thin film 12 on the flange 11f, with the thin film 12 spanning an aperture 11a encircled by the flange 11f, and with the adhesive 13 located between the thin film 12 and the flange 11f.

A third step (FIG. 1) can include curing the adhesive 13 to form a hermetic seal between the thin film 12 and the flange 11f. Example minimum temperatures for the cure include ≥30° C., ≥45° C., or ≥55° C. Example maximum temperatures for the cure include ≤70° C., ≤90° C., ≤150° C., or ≤350° C. Example cure time is ≥ 30 minutes and ≤ five hours.

What is claimed is:

1. An x-ray window comprising:
a housing including a flange encircling an aperture;
a thin film located on the flange and spanning the aperture;
an adhesive between an outer ring of the thin film and the flange, the adhesive mounting the thin film to the housing; and
the adhesive comprising silver and carbon.

2. The x-ray window of claim 1, wherein the adhesive adjoins the flange and the thin film and forms a hermetic seal between the flange and the thin film.

3. The x-ray window of claim 1, wherein the x-ray window is capable of withstanding ≥300° C. without degradation.

4. The x-ray window of claim 1, wherein the adhesive includes ≥10 weight percent and ≤30 weight percent epoxy resin.

5. The x-ray window of claim 1, wherein the adhesive includes ≥30 weight percent and ≤60 weight percent silver.

6. The x-ray window of claim 1, wherein the adhesive includes ≥50 weight percent and ≤70 weight percent silver.

7. The x-ray window of claim 1, wherein the adhesive includes ≥0.01 weight percent and ≤1 weight percent graphene.

8. The x-ray window of claim 1, wherein the adhesive includes ≥10 weight percent and ≤30 weight percent methyl-5-norbornene-2,3-dicarboxylic anhydride.

9. The x-ray window of claim 1, wherein the adhesive includes ≥1 weight percent and ≤5 weight percent glycerol.

10. The x-ray window of claim 1, wherein the adhesive includes ≥1 weight percent and ≤5 weight percent trimellitic anhydride.

11. The x-ray window of claim 1, wherein the adhesive includes ≤0.1 weight percent imidazole.

12. The x-ray window of claim 1, wherein the adhesive has a Shore Hardness that is at least 70 D.

13. The x-ray window of claim 1, wherein the adhesive has a flexural modulus that is ≥100 MPa and ≤350 MPa.

14. The x-ray window of claim 1, wherein the adhesive has a volume resistivity that is ≤0.01 Ω-cm.

15. An x-ray window comprising:
a housing including a flange encircling an aperture;
a thin film located on the flange and spanning the aperture;
an adhesive between an outer ring of the thin film and the flange, the adhesive mounting the thin film to the housing;
the adhesive comprising silver and carbon;
the adhesive includes ≥50 weight percent and ≤70 weight percent silver; and
the adhesive includes ≥0.01 weight percent and ≤1 weight percent graphene.

16. The x-ray window of claim 15, wherein the adhesive includes ≥50 weight percent and ≤70 weight percent silver.

17. The x-ray window of claim 15, wherein the adhesive includes ≥10 weight percent and ≤30 weight percent epoxy resin.

18. The x-ray window of claim 15, wherein the adhesive adjoins the flange and the thin film and forms a hermetic seal between the flange and the thin film.

19. A method of making an x-ray window, the method comprising:
placing an adhesive on a flange of a housing, on an outer ring of a thin film, or on both, the adhesive including silver and carbon;
placing the thin film on the flange, with the thin film spanning an aperture encircled by the flange, and with the adhesive located between the thin film and the flange; and
curing the adhesive at a temperature of ≥45° C. for ≥30 minutes and ≤ five hours to form a hermetic seal between the thin film and the flange.

20. The method of claim 19, wherein curing the adhesive is performed at ≤90° C.
